(19) United States
(12) Patent Application Publication
(10) Pub. No.: US 2026/0133084 A1
(43) Pub. Date: May 14, 2026

(54) METHOD FOR INTELLIGENT DENOISING AND MISSING VALUE IMPUTATION OF DISTRIBUTED OPTICAL FIBER STRAIN DATA

(71) Applicant: Institute of Rock and Soil Mechanics, Chinese Academy of Sciences, Wuhan (CN)

(72) Inventors: Pengzhi PAN, Wuhan (CN); Xiujun ZHANG, Wuhan (CN); Shuting MIAO, Wuhan (CN); Yujie FENG, Wuhan (CN); Zhaofeng WANG, Wuhan (CN); Xufeng LIU, Wuhan (CN); Qingsong ZHENG, Wuhan (CN); Wenbo HOU, Wuhan (CN); Ning YANG, Wuhan (CN)

(21) Appl. No.: 19/444,104

(22) Filed: Jan. 8, 2026

(30) Foreign Application Priority Data
Apr. 21, 2025 (CN) 202510494410.4

(51) Int. Cl. G01L 1/26; G01B 11/16; G01L 1/24

(52) U.S. Cl. CPC G01L 1/26; G01B 11/16; G01L 1/242

(57) ABSTRACT

A method for intelligent denoising and missing value imputation of distributed optical fiber strain data, in which a distributed optical fiber is coupled to a rock sample under triaxial test conditions; an original optical fiber strain data is collected through a distributed optical-fiber monitoring system; the original optical fiber strain data is arranged in a chronological order and preprocessed to obtain noise-free optical fiber strain data; a noise identification and data imputation model is constructed and trained using the noise-free optical fiber strain data; denoising and missing value imputation are performed on optical fiber strain data containing spatial location information based on the trained noise identification and data imputation model; and parameters of the trained noise identification and data imputation model are dynamically updated in real time according to temporal variations of a strain field within a monitored space.

### CROSS-REFERENCE TO RELATED APPLICATIONS

This application claims the benefit of priority from Chinese Patent Application No. 202510494410.4, filed on Apr. 21, 2025. The content of the aforementioned application, including any intervening amendments made thereto, is incorporated herein by reference in its entirety.

### TECHNICAL FIELD

This application relates to distributed optical fiber-based monitoring techniques, and more particularly to a method for intelligent denoising and missing value imputation of distributed optical fiber strain data.

### BACKGROUND

Large-scale monitoring of rocks is essential for evaluating and predicting the stability of rock structures. The creep deformation and failure of brittle rocks are considered to be the result of the slow coalescence of microcracks under static conditions, and the failure process is abrupt and difficult to predict using conventional rock deformation monitoring methods. Since traditional rock deformation monitoring primarily focuses on single-point measurements at critical locations of engineering structures, while rock failure exhibits localization characteristics where local fractures may rapidly propagate leading to structural failure across large areas. Therefore, long-term distributed high-precision monitoring of rock surfaces under extreme conditions such as high pressure is of great significance for capturing local ruptures and predicting rock failure.

Distributed optical fiber technology, as an emerging monitoring method, enables long-term distributed monitoring of rock surfaces. Among such techniques, optical frequency domain reflectometry (OFDR)-based monitoring techniques offer high spatial resolution, high temporal resolution, and high precision. When combined with uncoated distributed optical fibers that exhibit high strain transfer efficiency, OFDR can capture minor deformations caused by microcrack propagation and coalescence. Currently, distributed optical fiber strain monitoring technology has been applied to acquire unconfined rock surface deformations. However, under extreme environments such as high triaxial pressure, protecting the optical fiber while obtaining deformation data from rock surfaces is equally important for understanding rock shear failure mechanisms. Nevertheless, fiber bending or large rock deformations may cause localized optical loss along the optical path, resulting in complex noise mixed into the monitoring data, which interferes with subsequent data processing and analysis. Traditional denoising methods generally assume a normal distribution of the data or rely on statistical rules for noise identification. While these methods have broad applicability, their accuracy still requires improvement. In recent years, machine learning-based denoising algorithms have been widely adopted, such as isolation forest. However, such tree-based algorithms require specifying the proportion of outliers, which often leads to misclassification or omission of noise points and results in a long computation time. Meanwhile, common missing-value imputation methods, such as nearest-neighbor interpolation and machine learning-based time series prediction, struggle to simultaneously account for both temporal continuity and the spatial distribution during rock deformation processes.

The present disclosure provides a method for long-term monitoring of a 250-μm-diameter distributed optical fiber under a triaxial high-pressure condition while protecting such optical fiber. By combining a convolutional neural network with an autoencoder and taking into account the temporal continuity and spatial distribution of rock deformation, the method enables intelligent identification of noise points and imputation of missing values in distributed optical fiber data under static monitoring conditions.

### SUMMARY

An object of the disclosure is to provide a method for protecting a 250-μm-diameter distributed optical fiber and collecting strain data under a triaxial high-pressure condition, and further to provide a method for intelligent detection of noise points and imputation of missing data in strain monitoring data, thereby addressing the problem of abundant noise and data loss in optical fiber measurements during high-pressure, long-duration, and static monitoring of rock deformation.

Technical solutions of the present disclosure are described as follows.

In a first aspect, this application provides a method for intelligent denoising and missing value imputation of distributed optical fiber strain data, comprising:
under triaxial test conditions, coupling a distributed optical fiber to a rock sample, and collecting, by a distributed optical-fiber monitoring system, an original optical fiber strain data of the rock sample; wherein the original optical fiber strain data contains spatial location information;
arranging the original optical fiber strain data in a chronological order followed by preprocessing to obtain a plurality of sets of noise-free optical fiber strain data;
constructing a noise identification and data imputation model; and training the noise identification and data imputation model using the plurality of sets of noise-free optical fiber strain data to obtain a trained noise identification and data imputation model;
performing denoising and missing value imputation on optical fiber strain data containing spatial location information based on the trained noise identification and data imputation model to obtain denoised and data-imputed optical fiber strain data; and
updating parameters of the trained noise identification and data imputation model in real time according to temporal variations of a strain field within a monitored space.

In some embodiments, the step of arranging the original optical fiber strain data in a chronological order followed by preprocessing to obtain the plurality of sets of noise-free optical fiber strain data comprises:
arranging the original optical fiber strain data in a chronological order;
subjecting, for each time point, the optical fiber strain data containing spatial location information to normalization to obtain a plurality of sets of normalized optical fiber strain data; and
performing dimensional transformation on the plurality of sets of normalized optical fiber strain data to convert each of the plurality of sets of normalized optical fiber strain data from a one-dimensional form to a two-dimensional form, wherein strain value at each spatial location occupies a separate dimension.

In some embodiments, the noise identification and data imputation model comprises the encoder and the decoder; the encoder comprises a first fully connected layer, a convolutional layer and a pooling layer; and the decoder comprises a transposed convolution layer, an upsampling layer and a second fully connected layer.

In some embodiments, the step of training the noise identification and data imputation model using the plurality of sets of noise-free optical fiber strain data to obtain the trained noise identification and data imputation model comprises:
inputting a first set of noise-free optical fiber strain data into an encoder;
performing, through a first fully connected layer, multivariate expression of the first set of noise-free optical fiber strain data to output multivariate data;
extracting, by a convolutional layer, features from the multivariate data; and reducing, by a pooling layer, sizes of the features to output high-dimensional feature data; and
inputting the high-dimensional feature data from the encoder into a decoder;
performing, by a transposed convolution layer of the decoder, transposed convolution on the high-dimensional feature data to restore spatial resolution, followed by data detail restoration using an upsampling layer and reconstruction using a second fully connected layer to output reconstructed data;
comparing a second set of noise-free optical fiber strain data with the reconstructed data, predicted by the noise identification and data imputation model based on last time point, to compute a value of a loss function; adjusting parameters of the noise identification and data imputation model based on the value of the loss function; and performing iterative training according to a preset learning rate to obtain the trained noise identification and data imputation model.

In some embodiments, the step of performing denoising and missing value imputation on the optical fiber strain data containing spatial location information based on the trained noise identification and data imputation model to obtain the denoised and data-imputed optical fiber strain data comprises:
predicting strain data at different spatial locations at a first time point using the trained noise identification and data imputation model; and calculating a mean squared error between a predicted value and a measured value;
if the mean squared error exceeds a predetermined threshold, determining the strain data at a corresponding position as a noise point and recording spatial location information of the noise point; and
performing missing value imputation on the noise point.

In some embodiments, the missing value imputation is performed on the noise point through the following formula:

$${ε}_{i} = {ε}_{s , t , i} σ + \overline{ε} ;$$

wherein εᵢ represents a missing strain value at a i-th position at a current time point, ε̅ represents a mean value of a spatial strain field at a time point/corresponding to the missing strain value, σ represents a standard deviation of the spatial strain field at the time point t corresponding to the missing strain value, ε_{s,t,i} represents a normalized strain value at the i-th position at the time point/predicted by the noise identification and data imputation model, i represents a position of an i-th noise point, and t represents the current time point corresponding to prediction conducted by the noise identification and data imputation model.

In some embodiments, the step of updating the parameters of the trained noise identification and data imputation model in real time according to temporal variations of the strain field within the monitored space comprises:
after noise identification and missing value imputation on optical fiber strain data at a (t−1)-th time point;
inputting optical fiber strain data at a (t−2)-th time point to the trained noise identification and data imputation model to obtain predicted optical fiber strain data;
calculating a reconstruction error between the predicted optical fiber strain data and the denoised and data-imputed optical fiber strain data at the (t−1)-th time point; and
allowing the trained noise identification and data imputation model to learn spatial strain distribution at the (t−1)-th time point and update the parameters of the trained noise identification and data imputation model.

In some embodiments, the method, after the missing value imputation, further comprises:
removing Gaussian noise from the denoised and data-imputed optical fiber strain data via weighted averaging through steps of:
calculating a one-dimensional convolution kernel based on a Gaussian function;
performing, for each time point, an equal-length convolution operation on the denoised and data-imputed optical fiber strain data using the one-dimensional convolution kernel to obtain Gaussian-filtered strain data; and
replacing the denoised and data-imputed optical fiber strain data with the Gaussian-filtered strain data to remove Gaussian noise.

Compared to the prior art, the present disclosure has the following beneficial effects.

The present disclosure provides a method for long-term, full-field monitoring of rock surface deformation using uncoated distributed optical fibers under a triaxial high-pressure condition, thereby enabling the acquisition of high-precision strain data in complex stress environments.

In the present disclosure, a deep learning approach based on an encoder-decoder architecture is employed to automatically learn data features, which accelerates convergence during training and reduces computational resource consumption. An incremental training mechanism further enables the noise identification and data imputation model to update its parameters in real time according to temporal variations of the strain field, ensuring effectiveness and stability of the model during long-term monitoring. In data processing, both data distribution and temporal continuity are comprehensively considered to effectively identify and handle noise points and reasonably impute missing values, thereby ensuring data completeness and accuracy. For Gaussian noise, a one-dimensional convolution kernel and same-length convolution operation are applied after missing value imputation to efficiently remove noise and prevent misjudgment. This provides high-precision data processing support for related monitoring applications and has significant engineering value.

### BRIEF DESCRIPTION OF THE DRAWINGS

The accompanying drawings are merely exemplary and are not intended to limit the scope of the present disclosure. The accompanying drawings are to be read in conjunction with the specification and the claims for a full understanding of the disclosed embodiments. Where appropriate, identical reference numerals are employed throughout the drawings to denote the same or corresponding elements. Such embodiments are exemplary and are not intended to be exhaustive or to limit the scope of the device or method provided herein.

FIG. 1 structurally illustrates a device and a monitoring process according to an embodiment of the present disclosure;

FIG. 2 is a flowchart of a method for intelligent denoising and missing value imputation of distributed optical fiber strain data according to an embodiment of the present disclosure; and

FIG. 3A-3B structurally show an original data and denoised data according to an embodiment of the present disclosure.

### DETAILED DESCRIPTION OF EMBODIMENTS

It should be noted that, unless otherwise stated or contradictory, features of the embodiments and examples described herein may be combined with one another. The present disclosure will be described in detail below with reference to the accompanying drawings and the embodiments.

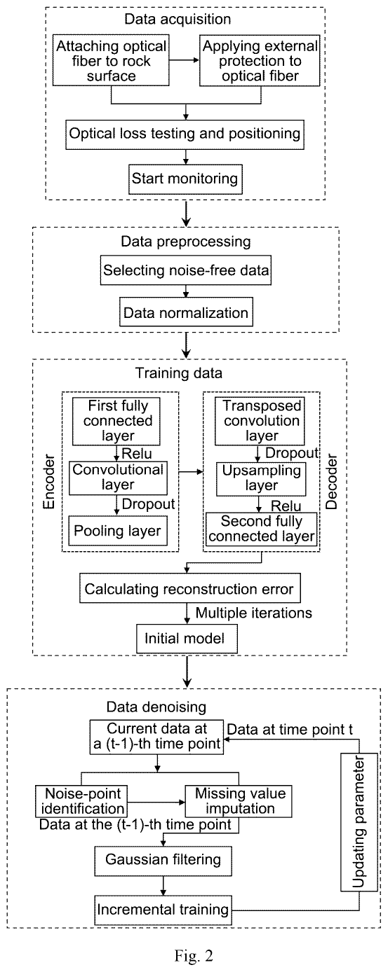

Referring to FIG. 2, an embodiment of the present disclosure provides a method for protecting a 250-μm-diameter distributed optical fiber under harsh conditions to monitor rock deformation and perform denoising and missing value imputation on strain data. The method includes the following steps.

Step (1) Under triaxial test conditions, a distributed optical fiber is effectively coupled with a rock sample.

A 250-μm-diameter G652b single-mode uncoated distributed optical fiber is selected. First, a fiber-laying path is determined, and an optical fiber layout is marked on a surface of a to-be-tested specimen using a waterproof marker. The distributed optical fiber is then laid along the predetermined layout on the rock surface, ensuring that no excessive bends occur during laying. A certain pre-press is maintained during the laying process, such that the distributed optical fiber is in full contact with a surface of a to-be-tested rock. A fast-curing adhesive with a high elastic modulus is used as a coupling agent to affix the distributed optical fiber onto the rock surface, and care is taken during the affixing process to prevent any damage to the optical fiber.

A sealing adhesive having a thickness greater than 5 mm is applied to the rock surface on which the optical fiber is affixed, so as to prevent hydraulic oil in a triaxial chamber from penetrating the rock during the test. At the same time, the sealing adhesive serves to protect the optical fiber from external environmental interference. The sealing adhesive is selected to be waterproof, high-temperature resistant, corrosion-resistant, and capable of withstanding large deformations.

The to-be-tested specimen with the wrapped optical fiber is placed into the triaxial chamber. One end of the optical fiber is led out from a triaxial testing machine as an input end for inputting optical signals, while the other end of the optical fiber serves as an output end for the optical signals. The output end of the optical fiber is knotted to reduce the influence of optical loss at the fiber fracture on the test results.

The optical fiber affixed to the rock is spliced to the optical fiber connected to a demodulator, ensuring that an optical loss is less than 0.01 dB. The optical fiber is then inspected using a laser pointer or the demodulator to verify that optical signals can be transmitted normally.

Step (2) Data acquisition is performed using a distributed optical-fiber monitoring system.

The distributed optical fiber monitoring system includes a strain sensing section and a data-processing and control system. The strain sensing section consists of the distributed optical fiber affixed to the to-be-tested rock. The data-processing and control system includes a distributed optical fiber signal demodulator and a computer host.

Prior to testing, optical loss in the optical fiber is checked to ensure that the optical loss does not significantly increase with the extension of the measurement distance. Position calibration is performed by pressing the optical fiber to determine the start and end positions of data acquisition.

In the data-processing and control system, corresponding data parameters are set, including a strain transfer coefficient and a temperature transfer coefficient of the selected optical fiber, as well as a spatial resolution and a temporal resolution for data acquisition. The device selected in the present disclosure is based on Optical Frequency Domain Reflectometry (OFDR), capable of acquiring strain data with a sampling precision of 1με.

Further, a triaxial compression test of the rock is performed on a triaxial testing machine, in which test loading and data acquisition are carried out synchronously. The oil pressure in the triaxial chamber is first increased to 60 MPa. If the optical fiber can operate continuously and normally under high pressure, and then a triaxial compression creep test is initiated until the rock failure occurs.

Step (3) Data acquired by the distributed optical-fiber monitoring system is arranged in a chronological order and preprocessed.

The strain distributions obtained from the distributed optical fiber are arranged in a chronological order and preprocessed, including screening noise-free data, normalizing the input data, and performing dimensional transformation on the normalized data.

In an early stage of monitoring, at least one set of noise-free data are manually selected for training the model. The noise-free data are required to meet the following conditions: no values exceed the measurement limit of the device, the data vary continuously without abrupt changes, and the acquisition time points of the data are as close as possible to those of the data requiring denoising.

In a first step of the preprocessing of the time-series data, for each time point, the strain data containing spatial location information is subjected to normalization, such that magnitude characteristics of the data are removed and only variation trends of the data are retained. Mean values of the data samples at each time point is converted to 0, and standard deviations of the data samples at each time point is converted to 1. The normalization is calculated according to the following formula:

$${ε}_{s , i} = \frac{{ε}_{i} - \overline{ε}}{σ} .$$

In the above formula, εᵢ represents a strain value at an i-th position in the data at a given time point, ε̅ represents a mean strain value of the data acquired at the given time point, σ is a standard deviation of the data, and ε_{s,i} represents a normalized value of εᵢ.

After normalization, the data are subjected to dimensional transformation. Each set of normalized data is converted from a one-dimensional form to a two-dimensional form, in which the strain value at each spatial location occupies a separate dimension. The transformation is expressed as:

$$[ {ε}_{1} , {ε}_{2} … , {ε}_{i} , … , {ε}_{n} ] \to [ [ {ε}_{1} ] , [ {ε}_{2} ] … , [ {ε}_{i} ] , … , [ {ε}_{n} ] ] .$$

After the transformation, the shape of the dataset changes from (m, n) to (m, n, 1), where a first-dimension m represents different time points, and a second-dimension n represents the number of monitoring points. This transformation removes the spatial order features in the data and enables the model to learn strain features from all spatial locations simultaneously, thereby reducing model parameters and training cost.

Step (4) An encoder and a decoder are constructed, and parameters of the model are trained.

The noise-free data after the normalization and dimensional transformation in step (3) is input into the encoder and the decoder for data reconstruction. The encoder includes a first fully connected layer, a convolutional layer, and a pooling layer. The decoder includes a transposed convolution layer, an upsampling layer, and a second fully connected layer.

4.1 Inputting Training Data into the Encoder

The single strain data is subjected to multivariate representation. Data at a (t−1)-th time point is input into two first fully connected layers, such that the strain at each spatial location is represented by a set of values. A ReLU activation function is applied between the two first fully connected layers, expressed as:

$$\begin{matrix}{X}_{k \times 1} = {W}_{k \times 1} {X}_{1 \times 1} + {b}_{1} ; \\ and \\ {Y}_{1} = {W}_{v \times k} {X}_{k \times 1} + {b}_{2} .\end{matrix}$$

In the above formulas, W_{k×1} and W_{v×k} represent weight matrices; b₁ and b₂ represent bias terms; k is the number of output nodes in a first layer of the two first fully connected layers; v is the number of output nodes in a second layer of the two first fully connected layers; X_{1×1} represent an input to the first layer of the two first fully connected layers, and X_{k×1} represent an output of the first layer of the two first fully connected layers; and Y₁ represents data obtained after processing through the two first fully connected layers.

The multivariate data output from the first fully connected layers is subjected to feature extraction through a convolutional layer. For each time point, the data are reshaped into a tensor of size (n, 1, v), where n is the number of monitoring points, and v is the number of nodes in the last layer of the first fully connected layers.

Feature extraction is performed using a convolutional kernel with an input channel of 1, an output channel of d, a kernel size of 3, a stride of 1, and a padding of 1. The resulting data is then processed through the ReLU activation function. During this process, a dropout layer is applied to prevent overfitting of the parameters. Subsequently, the sizes of the feature maps are reduced by a pooling layer. The aforementioned convolution and pooling procedures are repeated to further increase feature channel dimensions and reduce the sizes of the feature maps.

4.2 Inputting Extracted Data Features into the Decoder

The high-dimensional feature data extracted by the convolutional layers are fed into the decoder, the decoder has a structure opposite to that of the encoder. The transposed convolution layers correspond to the convolutional layers in the encoder, and the upsampling layers correspond to the pooling layers. The numbers of input and output channels in the transposed convolution layers correspond to the output and input channels of the convolutional layers, respectively, while other hyperparameters remain the same as in the encoder. Through the deconvolution and upsampling processes, the data dimensions are progressively restored.

After the final upsampling layer is completed, the data with a shape of (n, 1, v) is restored to a shape of (n, v) and fed into a second fully connected layer for data reconstruction. The ReLU activation function is applied during this process. The reconstructed data for each set have a shape of (n, 1), which matches the noise-free data after the normalization and dimensional transformation and represents the strain value at each spatial position (n).

### 4.3 Calculating a Reconstruction Error as a Loss Function

A mean squared error between the noise-free data after the normalization and dimensional transformation at time point/and model-predicted output data is calculated to evaluate the prediction performance of the model, according to the following formula:

$$MSELoss ( X , Y ) = \frac{{{Σ}_{1}^{n} ( {y}_{i} - {x}_{i} )}^{2}}{n} .$$

In the above formula, xᵢ represents the noise-free data after the normalization and dimensional transformation, yᵢ is the reconstructed data, and n is the number of monitoring points in a data set.

### 4.4 Iteratively Training the Model

The noise-free data selected in step (3) is sequentially fed into the model in chronological order according to a preset number of training iterations. During each iteration, steps 4.1-4.3 are repeated. The learning rate is set to 0.001, and training continues for an appropriate number of iterations until the loss function becomes sufficiently small and stable. Upon completion of the iterations, the trained initial model is obtained.

Step (5) Based on the trained initial model, noise-point identification, missing value imputation and Gaussian denoising are performed on all temporal strain data containing spatial location information. Parameters of the trained initial model are updated in real time according to temporal variations of a strain field within a monitored space.

### 5.1 Noise-Point Identification and Missing Value Imputation

Using the initial model trained in step 4.4, normalized strain values at different spatial positions at a first time point are predicted. An error is calculated according to the formula in step 4.3, strain values having an error greater than 1 are regarded as noise points, and spatial positions of the noise points are recorded.

Further, missing value imputation is performed for the strain values at the noise points. The missing values are imputed based on model-predicted results and the strain-data distribution at the current time point, expressed as:

$${ε}_{i} = {ε}_{s , t , i} σ + \overline{ε} .$$

In the above formula, εᵢ represents a missing strain value at a i-th position at the current time point, ε̅ represents a mean value of a spatial strain field at a time point t corresponding to the missing strain value, σ represents a standard deviation of the spatial strain field at the time point/corresponding to the missing strain value, ε_{s,t,i} represents a normalized strain value at the i-th position at the time point/predicted by the model, i represents a position of an i-th noise point, and/represents the current time point corresponding to prediction conducted by the model.

### 5.2 Incremental Training for Dynamic Updating of Model Parameters and Gaussian Filtering

During static monitoring, the spatial strain field changes slowly over time. Therefore, the model is required to continuously learn the evolving state of the strain field and update its parameters in real time.

The noise-free data at the last time point are processed through steps 4.1-4.4 to perform incremental training as input for updating the model parameters. During the computation of the loss function in this incremental training, a mean squared error is calculated between the reconstructed data and denoised strain data at the first time point. The updated model is then applied to strain data at a second time point for noise-point identification, and step 5.1 is repeated to complete the noise-point identification and missing value imputation for the second time point.

After completing noise-point identification and missing value imputation for strain data at the (t−1)-th time point, denoised strain data at a (t−2)-th time point is used as an input to compute a reconstruction error between an output of the model and the strain data at the (t−1)-th time point. This allows the model to learn the spatial strain distribution at the (t−1)-th time point and update its parameters. The updated model then repeats steps 4.1-4.4 to perform denoising for the strain data at the time point t, with denoised strain data at the (t−1)-th time point being input.

During the monitoring process, due to limitations in instrument accuracy and external disturbances, minor Gaussian noise may occur within strain data. This noise differs slightly from the original data and may not be recognized as a noise point. However, during parameter updating and data imputation, such noise could be learned as a feature and continuously reinforced, potentially misleading the model to misidentify normal data as noise, resulting in misjudgment and incorrect imputation. Therefore, after each missing value imputation, Gaussian noise in the data needs to be removed using a weighted averaging approach. First, a one-dimensional convolution kernel is calculated based on the Gaussian function, expressed as:

$$G ( {x}_{i} ) = {e}^{- \frac{{{x}_{i}}^{2}}{2}} ; and \\ {g}_{i} = G ( {x}_{i} ) / {\sum }_{- n}^{n} G ( {x}_{i} ) .$$

In the above formulas, xᵢ denotes an integer within a range of [−n,n], n represents a size of the convolution kernel, and gᵢ represents a corresponding weight value within the convolution kernel.

Further, the convolution kernel described above is applied to perform a convolution operation on the data at each time point, with the kernel size preferably not exceeding 3.

A one-dimensional convolution is performed on the denoised data using the one-dimensional convolution kernel obtained as described above. In the calculation, edge effects of the data are not considered, and the convolution is performed in a full-length manner, such that the number of input and output data points of the Gaussian filtering remains consistent. The number of input data points can be extended to avoid the influence of edge effects on the data within the effective monitoring range. Finally, the data obtained after Gaussian filtering are used to replace the original data.

Based on distributed optical fiber monitoring technology, the present disclosure also provides a method for protecting optical fibers under complex stress conditions such as triaxial high pressure, and performing noise-point identification and missing value imputation on strain field data under static monitoring conditions.

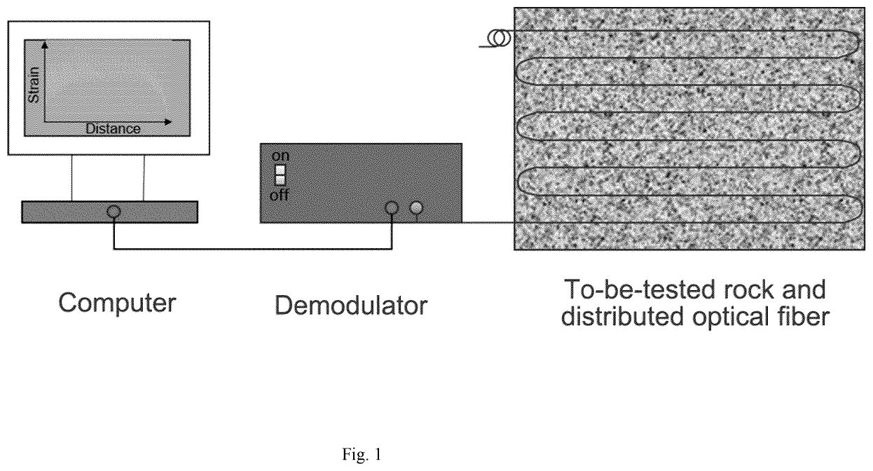

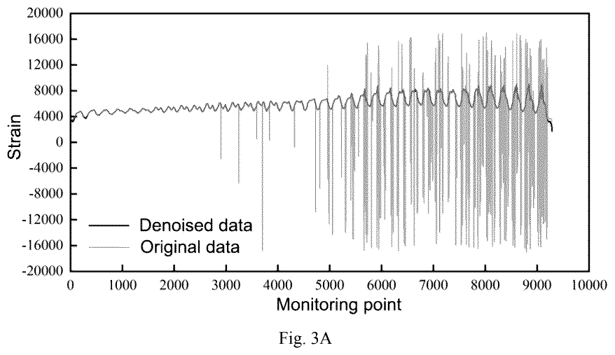

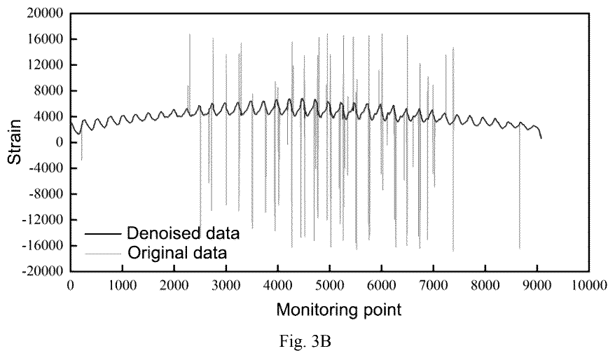

FIG. 1 shows a device and a monitoring process during testing. The testing environment is a laboratory setting with a confining pressure of 60 MPa, a duration of up to 9 h, a spatial resolution of 0.64-1 mm, and a measurement accuracy of up to 1με. FIGS. 3A-3B show a comparison of the data before and after processing, indicating that the method proposed in the present disclosure can achieve accurate denoising and complete missing value imputation, and that the model can adapt to temporal variations in the spatial distribution of strain data during monitoring.

The embodiments described above are merely preferred embodiments of the present disclosure, and are not intended to limit the scope of the present disclosure. Any equivalent structural changes made based on the description and the accompanying drawings of the present disclosure under the inventive concept of the present disclosure, or direct/indirect application in other related technical fields shall fall within the scope of the present disclosure defined by the appended claims.

What is claimed is:

1. A method for intelligent denoising and missing value imputation of distributed optical fiber strain data, comprising:
under triaxial test conditions, coupling a distributed optical fiber to a rock sample, and collecting, by a distributed optical-fiber monitoring system, an original optical fiber strain data of the rock sample; wherein the original optical fiber strain data contains spatial location information;
arranging the original optical fiber strain data in a chronological order followed by preprocessing to obtain a plurality of sets of noise-free optical fiber strain data;
constructing a noise identification and data imputation model; and training the noise identification and data imputation model using the plurality of sets of noise-free optical fiber strain data to obtain a trained noise identification and data imputation model;
performing denoising and missing value imputation on optical fiber strain data containing spatial location information based on the trained noise identification and data imputation model to obtain denoised and data-imputed optical fiber strain data; and
updating parameters of the trained noise identification and data imputation model in real time according to temporal variations of a strain field within a monitored space;
wherein the step of training the noise identification and data imputation model using the plurality of sets of noise-free optical fiber strain data to obtain the trained noise identification and data model comprises:
among the plurality of sets of noise-free optical fiber strain data, inputting a first set of noise-free optical fiber strain data into an encoder;
performing, through a first fully connected layer, multivariate representation of the first set of noise-free optical fiber strain data to output multivariate data;
extracting, by a convolutional layer, features from the multivariate data; and reducing, by a pooling layer, sizes of the features to output high-dimensional feature data;
inputting the high-dimensional feature data from the encoder into a decoder;
performing, by a transposed convolution layer of the decoder, transposed convolution on the high-dimensional feature data to restore spatial resolution, followed by data detail restoration using an upsampling layer and reconstruction using a second fully connected layer to output reconstructed data; and
comparing a second set of noise-free optical fiber strain data with the reconstructed data, predicted by the noise identification and data imputation model based on last time point, to compute a value of a loss function; adjusting parameters of the noise identification and data imputation model based on the value of the loss function; and performing iterative training according to a preset learning rate to obtain the trained noise identification and data imputation model; and
the method, after the missing value imputation, further comprises:
removing Gaussian noise from the denoised and data-imputed optical fiber strain data via weighted averaging through steps of:
calculating a one-dimensional convolution kernel based on a Gaussian function;
performing, for each time point, an equal-length convolution operation on the denoised and data-imputed optical fiber strain data using the one-dimensional convolution kernel to obtain Gaussian-filtered strain data; and
replacing the denoised and data-imputed optical fiber strain data with the Gaussian-filtered strain data to remove Gaussian noise.

2. The method of claim 1, wherein the step of arranging the original optical fiber strain data in a chronological order followed by preprocessing to obtain the plurality of sets of noise-free optical fiber strain data comprises:
arranging the original optical fiber strain data in a chronological order;
subjecting, for each time point, the optical fiber strain data containing spatial location information to normalization to obtain a plurality of sets of normalized optical fiber strain data; and
performing dimensional transformation on the plurality of sets of normalized optical fiber strain data to convert each of the plurality of sets of normalized optical fiber strain data from a one-dimensional form to a two-dimensional form, wherein strain value at each spatial location occupies a separate dimension.

3. The method of claim 1, wherein the noise identification and data imputation model comprises the encoder and the decoder; the encoder comprises a first fully connected layer, a convolutional layer and a pooling layer; and the decoder comprises a transposed convolution layer, an upsampling layer and a second fully connected layer.

4. The method of claim 1, wherein the step of performing denoising and missing value imputation on the optical fiber strain data containing spatial location information based on the trained noise identification and data imputation model to obtain the denoised and data-imputed optical fiber strain data comprises:
predicting strain data at different spatial locations at a first time point using the trained noise identification and data imputation model; and calculating a mean squared error between a predicted value and a measured value;
if the mean squared error exceeds a predetermined threshold, determining the strain data at a corresponding position as a noise point, and recording spatial location information of the noise point; and
performing missing value imputation on the noise point.

5. The method of claim 4, wherein the missing value imputation is performed on the noise point through the following formula:
$${ε}_{i} = {ε}_{s , t , i} σ + \overline{ε} ;$$
wherein εᵢ represents a missing strain value at a i-th position at a current time point, ε̅ represents a mean value of a spatial strain field at a time point t corresponding to the missing strain value, σ represents a standard deviation of the spatial strain field at the time point t corresponding to the missing strain value, ε_{s,t,i} represents a normalized strain value at the i-th position at the time point t predicted by the noise identification and data imputation model, i represents a position of an i-th noise point, and t represents the current time point corresponding to prediction conducted by the noise identification and data imputation model.

6. The method of claim 1, wherein the step of updating the parameters of the trained noise identification and data imputation model in real time according to temporal variations of the strain field within the monitored space comprises:
after noise identification and missing value imputation on optical fiber strain data at a (t−1)-th time point, inputting optical fiber strain data at a (t−2)-th time point to the trained noise identification and data imputation model to obtain predicted optical fiber strain data;
calculating a reconstruction error between the predicted optical fiber strain data and the denoised and data-imputed optical fiber strain data at the (t−1)-th time point; and
allowing the trained noise identification and data imputation model to learn spatial strain distribution at the (t−1)-th time point and update the parameters of the trained noise identification and data imputation model.
